(19) United States
(12) Patent Application Publication
(10) Pub. No.: US 2011/0236012 A1
(43) Pub. Date: Sep. 29, 2011

(54) Transmission apparatus and method of changing transmission route

(75) Inventor: Jun Wakabayashi, Kawasaki (JP)

(73) Assignee: FUJITSU LIMITED, Kawasaki (JP)

(21) Appl. No.: 12/929,906

(22) Filed: Feb. 23, 2011

(30) Foreign Application Priority Data
Mar. 29, 2010 (JP) 2010-075893

(51) Int. Cl. H04B 10/08

(52) U.S. Cl. 398/3

(57) ABSTRACT

A transmission apparatus located on a communication transmission line including a ring transmission line and a bypass transmission line, the transmission apparatus includes: a judging unit which judges whether or not there is a change request for a transmission route of a signal to be transmitted via the bypass transmission line; and a changing unit which changes the transmission route such that the signal which is to be transmitted via the bypass transmission line is transmitted via at least one portion of the ring transmission line, when it is judged that there is the change request.

### CROSS-REFERENCE TO RELATED APPLICATIONS

This application is based upon and claims the benefit of priority of the prior Japanese Patent Application No. 2010-075893, file on Mar. 29, 2010, the entire contents of which are incorporated herein by reference.

### FIELD

The present invention relates to a transmission apparatus for transmitting and receiving a signal and a method of changing a transmission route of the signal by the transmission apparatus. More specifically, the present invention relates to a transmission apparatus for transmitting and receiving a signal on a communication transmission line such as a backbone line, and a method of changing the transmission route of the signal by the transmission apparatus.

### BACKGROUND

As the communication standard adopted for a transmission line such as a backbone line or other transmission lines or the like, a SDH (Synchronous Digital Hierarchy) and a SONET (Synchronous Optical Network) are adopted. The SDH and the SONET have an APS (Automatic Protection Switch) function which allows a prompt response to a line failure by setting a work line and a protection line between two transmission apparatuses and by changing to the protection line when there is the line failure in the work line. As a configuration for realizing such an APS function on a ring-shaped ring transmission line, there is a configuration referred to as “BLSR (Bidirectional Line Switch Ring)”.
Patent document 1: Japanese Patent Application Laid Open No. Hei 10-117175
Patent document 2: Japanese Patent Application Laid Open No. Hei 10-233735
Patent document 3: Japanese Patent Application Laid Open No. Sho 57-097753
Patent document 4: Japanese Patent Application Laid Open No. Hei 10-234007

### SUMMARY

On the other hand, a bypass transmission line for bypassing predetermined two points on the ring transmission line may be laid in the ring transmission line, in some cases. Therefore, in order to stably transmit a signal, it is preferable to give high reliability to the bypass transmission line. However, the current BLSR merely defines a change in transmission route of the signal on the ring transmission line. Thus, the current BLSR cannot change the transmission route of the signal on the bypass transmission line. Therefore, in order to increase the reliability of the bypass transmission line, it may be preferable to lay a protection line of the bypass transmission line. In other words, it may be preferable to lay both the bypass transmission line for the work line and the bypass transmission line for the protection line. However, laying the two bypass transmission line may cause an increase in cost.

A transmission apparatus includes a judging unit and a changing unit. The transmission apparatus is a transmission apparatus located on a communication transmission line including a loop-shaped ring transmission line and a bypass transmission line for bypassing predetermined two points on the ring transmission line. The judging unit judges whether or not there is a change request for a transmission route of a signal which is to be transmitted via the bypass transmission line. The change request may be performed by the transmission apparatus itself (e.g. the transmission apparatus itself may perform the change request by detecting a link fault on the bypass transmission line). Alternatively, the change request may be performed by another transmission apparatus (e.g. the transmission apparatus itself notice of the change request which is made by another transmission apparatus detecting the link fault on the bypass the transmission apparatus itself). The changing unit changes the transmission route of the signal on the communication the transmission apparatus itself such that the signal which is to be transmitted via the bypass the transmission apparatus itself is transmitted via at least one portion of the ring the transmission apparatus itself. The change in the transmission route is preferably performed when it is judged by the judging unit that there is the change request for the transmission route of the signal which is to be transmitted via the bypass the transmission apparatus itself.

A method of changing a transmission route performs: the same operation as that performed by the judging unit described above; and the same operation as that performed by the changing unit described above.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a block diagram illustrating one example of the configuration of a transmission system in an embodiment;

FIG. 2 is a block diagram illustrating one example of the structure of a transmission apparatus in the embodiment;

FIG. 3 is a block diagram illustrating one example of the connection aspect of a work line by the transmission apparatus in the embodiment;

FIG. 4 is a block diagram illustrating one example of the connection aspect of a protection line by the transmission apparatus in the embodiment;

FIG. 5 is a flowchart illustrating a flow of an operation of generating topology bypass information by the transmission apparatus in the embodiment;

FIG. 6 are data structure diagrams illustrating one example of the topology bypass information;

FIG. 7 is a flowchart illustrating a flow of an operation of generating APS information by the transmission apparatus in the embodiment;

FIG. 8 is a flowchart illustrating a flow of an operation of changing a transmission route by the transmission apparatus in the embodiment;

FIG. 9 is a schematic diagram illustrating the state of the transmission system before the operation of changing the transmission route in a first specific example;

FIG. 10 are data structure diagrams illustrating one example of the APS information and the topology bypass information made by the operation of changing the transmission route in the first specific example;

FIG. 11 is a schematic diagram illustrating the state of the transmission system after the operation of changing the transmission route in the first specific example;

FIG. 12 is a schematic diagram illustrating the state of the transmission system before the operation of changing the transmission route in a second specific example;

FIG. 13 are data structure diagrams illustrating one example of the APS information and the topology bypass information made by the operation of changing the transmission route in the second specific example;

FIG. 14 is a schematic diagram illustrating the state of the transmission system after the operation of changing the transmission route in the second specific example;

FIG. 15 is a schematic diagram illustrating the state of the transmission system before the operation of changing the transmission route in a third specific example;

FIG. 16 are data structure diagrams illustrating one example of the APS information and the topology bypass information made by the operation of changing the transmission route in the third specific example; and

FIG. 17 is a schematic diagram illustrating the state of the transmission system after the operation of changing the transmission route in the third specific example.

### DESCRIPTION OF EMBODIMENT

Hereinafter, the embodiment will be explained with reference to the drawings.

### (1) Configuration of Transmission System

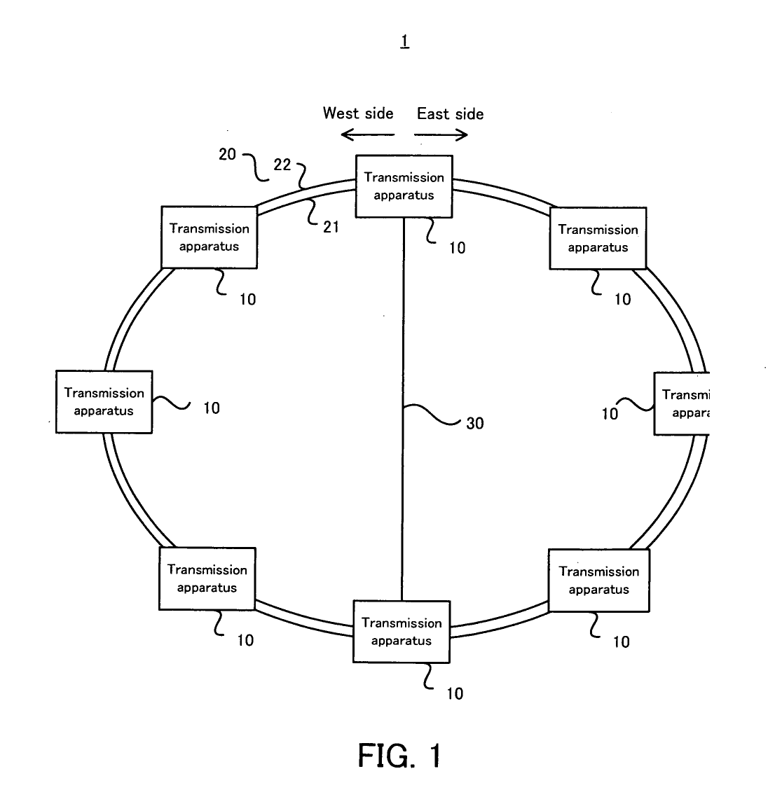

With reference to FIG. 1, the configuration of a transmission system 1 in an embodiment will be explained. FIG. 1 is a block diagram illustrating one example of the configuration of the transmission system 1 in the embodiment.

As illustrated in FIG. 1, the transmission system 1 in the embodiment includes a plurality of transmission apparatuses 10, a ring transmission line 20, and a bypass transmission line 30. As the transmission system 1, transmission systems which comply with, for example, a SDH (Synchronous Digital hierarchy and a SONET (Synchronous Optical Network) are listed as one example.

The plurality of transmission apparatuses 10 are connected to each other via the ring transmission line 20. In other words, each of the plurality of transmission apparatuses 10 is located at an arbitrary point on the ring transmission line 20. Moreover, two arbitrary transmission apparatus of the plurality of transmission apparatuses 10 are connected to each other via the bypass transmission line 30. By this, each of the plurality of transmission apparatuses 10 can use at least one of the ring transmission line 20 and the bypass transmission line 30 to perform the transmission and reception of a predetermined signal with another transmission apparatus 10.

The ring transmission line 20 is a transmission line with which the transmission and reception of a signal is performed between the plurality of transmission apparatuses 10. The ring transmission line 20 constitutes a ring network. The ring transmission line 20 includes, for example, an optical fiber. Moreover, one portion of the band of the ring transmission line 20 is used a work line 21, and another portion of the band of the ring transmission line 20 is used as a protection line 22.

The bypass transmission line 30 is a transmission line with which the transmission and reception of a signal is performed between the two arbitrary transmission apparatuses 10 of the plurality of transmission apparatuses 10. In other words, the bypass transmission line 30 is a transmission line for bypassing two arbitrary points on the ring transmission line 20. The bypass transmission line 30 includes, for example, an optical fiber. Incidentally, in the embodiment, the entire band of the bypass transmission line 30 is preferably used as a work line. In other words, in the embodiment, a new transmission line which constitutes a protection line of the bypass transmission line 30 may not be provided.

### (2) Structure of Transmission Apparatus

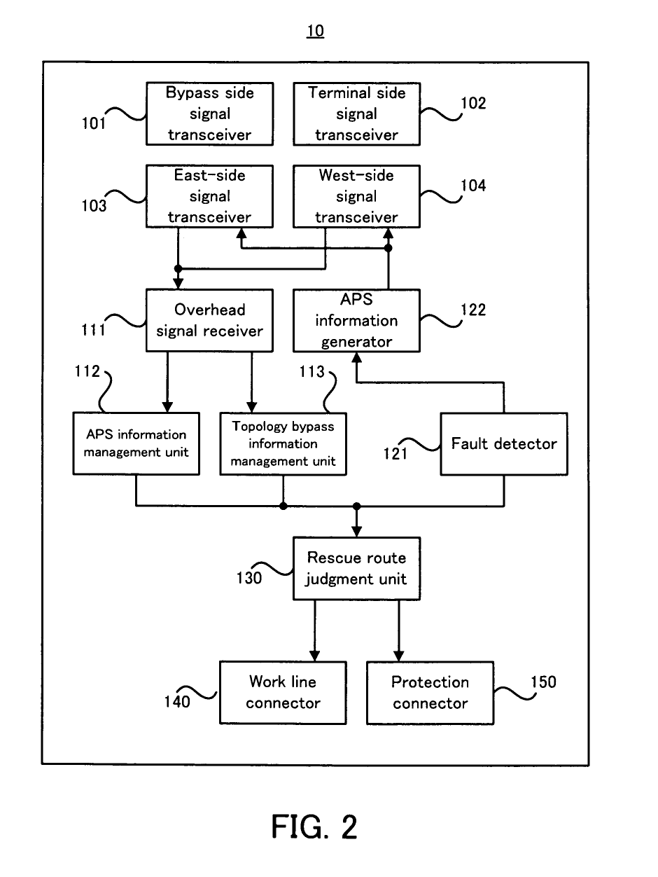

Next, with reference to FIG. 2, the structure of a transmission apparatus 10 in the embodiment will be explained. FIG. 2 is a block diagram illustrating one example of the structure of the transmission apparatus 10 in the embodiment.

As illustrated in FIG. 2, the transmission apparatus 10 includes a bypass-side signal transceiver 101; a terminal-side signal transceiver 102; an east-side signal transceiver 103; a west-side signal transceiver 104; an overhead signal receiver 111; an APS (Automatic Protection Switch) information management unit 112; a topology bypass information management unit 113; a fault detector 121; an APS information generator 122; a rescue route judgment unit 130 corresponding to one specific example of the “judging unit” and the “changing unit”; a work line connector 140; and a protection line connector 150.

The bypass-side signal transceiver 101 performs the transmission and reception of a signal from the transmission apparatus to the bypass transmission line 30.

The terminal-side signal transceiver 102 performs the transmission and reception of a signal from the transmission apparatus 10 to a not-illustrated terminal apparatus connected to the transmission apparatus 10.

The east-side signal transceiver 103 performs the transmission and reception of a signal from the transmission apparatus 10 to another transmission apparatus 10 connected to the east side (in other words, one side) of the transmission apparatus 10.

The west-side signal transceiver 104 performs the transmission and reception of a signal from the transmission apparatus 10 to another transmission apparatus 10 connected to the west side (in other words, the other side) of the transmission apparatus 10.

The overhead signal receiver 111 extracts an overhead signal included in the signal received by the east-side signal transceiver 103 or the west-side signal transceiver 104 (e.g. a frame such as a STM (Synchronous Transport Module) and a STS (Synchronous Transport Signal)).

The APS information management unit 112 extracts APS information included in the overhead signal extracted by the overhead signal receiver 111. Moreover, the APS information management unit 112 manages the extracted APS information by storing it in a not-illustrated memory or the like. Incidentally, the APS information has the same data structure as those of a K1 byte and a K2 byte in the SDH or SONET.

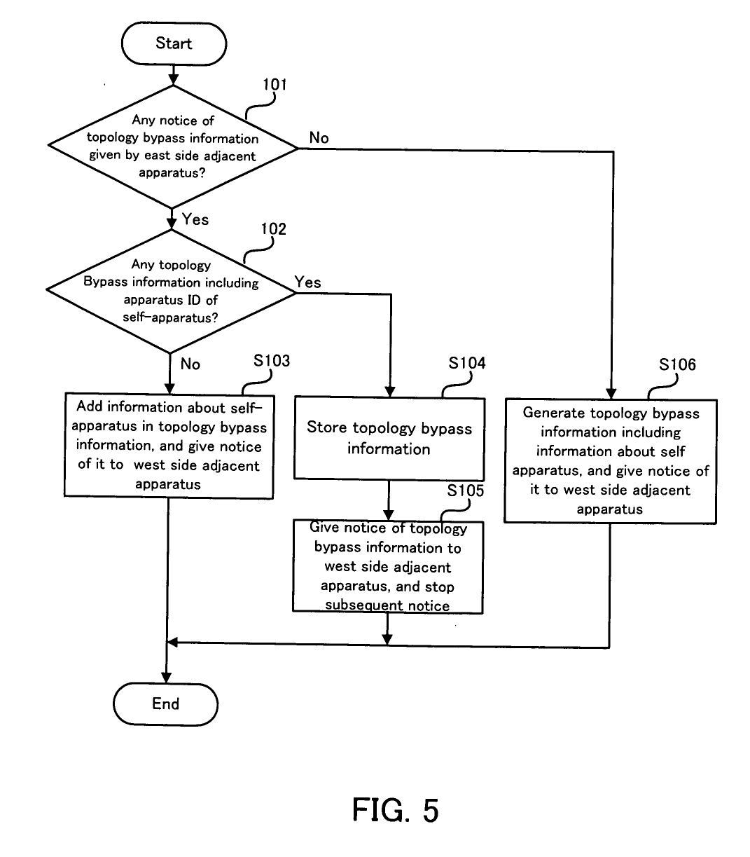

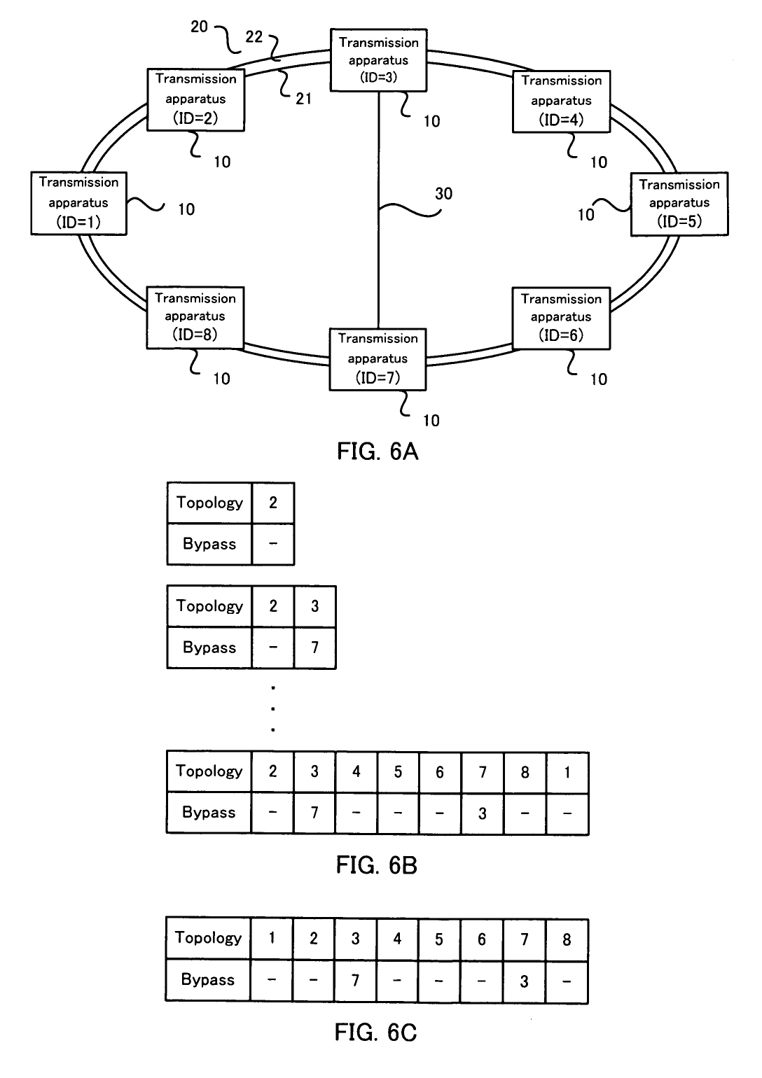

The topology bypass information management unit 113 extracts topology bypass information included in the overhead signal extracted by the overhead signal receiver 111. Moreover, the topology bypass information management unit 113 manages the extracted topology bypass information by storing it in a not-illustrated memory or the like. Incidentally, the topology bypass information will be detailed later (refer to FIG. 5 and FIG. 6).

The fault detector 121 detects whether or not a fault (e.g. link fault and the like) occurs on the ring transmission line 20 or the bypass transmission line 30.

The APS information generator 122 generates the APS information on the basis of the fault detected by the fault detector 121. Moreover, the APS information generator 122 gives notice of the generated APS information to another transmission apparatus 10 via the east-side signal transceiver 103 or the west-side signal transceiver 104.

The rescue judgment unit 130 changes a transmission route on the basis of the APS information managed by the APS information management unit 112 and the topology bypass information managed by the topology bypass information management unit 113, when the fault is detected by the fault detector 122 or when the APS information extracted by the APS information management unit 112 requests the change of the transmission route.

The work line connector 140 controls the connection between the transmission apparatus 10 and the work line 21 in the ring transmission line 20.

The protection line connector 150 controls the connection between the transmission apparatus 10 and the protection line 22 in the ring transmission line 20.

### (3) Aspect of Line Connection

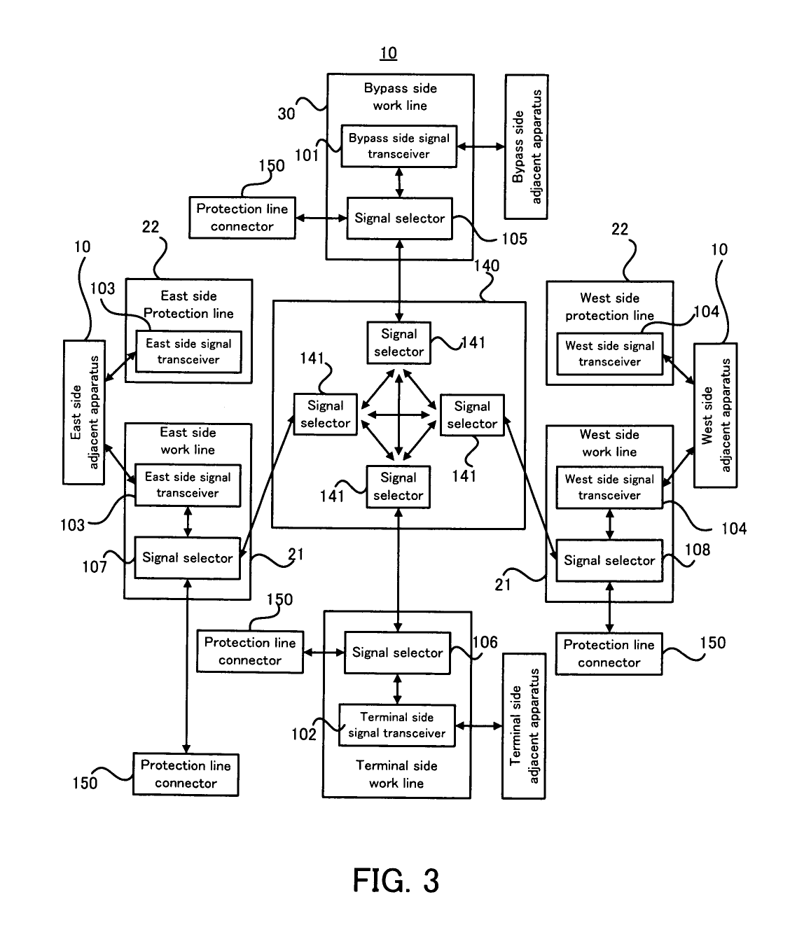

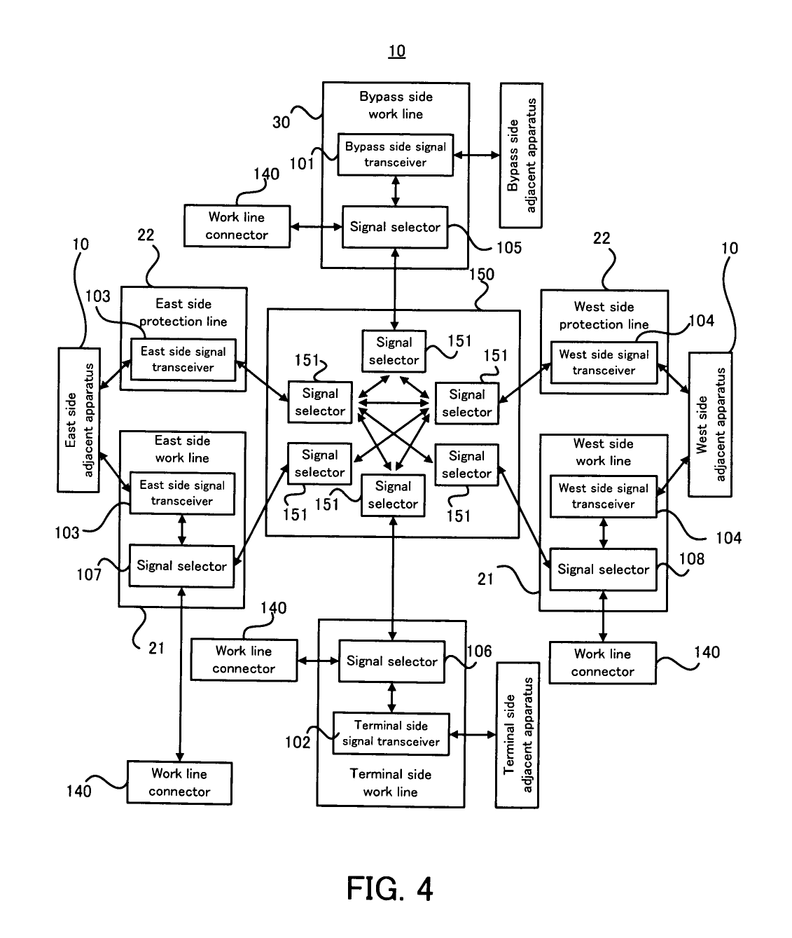

Next, with reference to FIG. 3 and FIG. 4, an explanation will be given on one example of the connection aspects of the work line 21 and the protection line 22 by the transmission apparatus 10 in the embodiment. FIG. 3 is a block diagram illustrating one example of the connection aspect of the work line 21 by the transmission apparatus 10 in the embodiment. FIG. 4 is a block diagram illustrating one example of the connection aspect of the protection line 22 by the transmission apparatus 10 in the embodiment.

As illustrated in FIG. 3, when the transmission apparatus 10 transmits the signal by using the work line 21 of the ring transmission line 20, the signal from the bypass side (i.e. the bypass transmission line 30 side), the signal from the terminal side (i.e. the not-illustrated terminal apparatus connected to the relevant transmission apparatus), the signal from the east side (i.e. the east side of the ring transmission line 20) and the signal from the west side (i.e. the west side of the ring transmission line 20) are added (ADD), are dropped (DROP) or passed through (THRU) via the work line connector 140. Incidentally, a directional line in FIG. 3 illustrates the transmission route of the signal. The adding (ADD), dropping (DROP) or passing (THRU) of the signal is performed by a signal selecting operation on a plurality of signal selectors 141 included in the work line connector 140 so as to correspond to the respective work lines on the bypass side, the terminal side, the east side, and the west side. Moreover, the selecting operation on the work line connector 140 and the protection line connector 150 for performing the transmission and reception of the signal (i.e. the adding (ADD), dropping (DROP) or passing (THRU) of the signal) is performed by a signal selecting operation on a signal selector 105 included in the bypass-side of the transmission apparatus 10, a signal selecting operation on a signal selector 106 included in the terminal-side of the transmission apparatus 10, a signal selecting operation on a signal selector 107 included in the east-side of the transmission apparatus 10, and a signal selecting operation on a signal selector 108 included in the west-side of the transmission apparatus 10.

In the same manner, as illustrated in FIG. 4, when the transmission apparatus 10 transmits the signal by using the protection line 22 of the ring transmission line 20, the signal from the bypass side, the signal from the terminal side, the signal from the east side and the signal from the west side are added (ADD), are dropped (DROP) or passed through (THRU) via the protection line connector 150. Incidentally, a directional line in FIG. 4 illustrates the transmission route of the signal. The adding (ADD), dropping (DROP) or passing (THRU) of the signal is performed by a signal selecting operation on a plurality of signal selectors 151 included the protection line connector 150 so as to correspond to the respective protection lines on the bypass side, the terminal side, the east side, and the west side.

### (4) Operation Examples

Next, with reference to FIG. 5 to FIG. 8, the operation examples of the transmission apparatus 10 in the embodiment will be explained.

### (4-1) Operation of Generating Topology Bypass Information

Firstly, with reference to FIG. 5, an explanation will be given on an operation of generating the topology bypass information by the transmission apparatus 10 in the embodiment. FIG. 5 is a flowchart illustrating a flow of the operation of generating the topology bypass information by the transmission apparatus 10 in the embodiment.

As illustrated in FIG. 5, the topology bypass information management unit 113 judges whether or not notice of the topology bypass information is given from another transmission apparatus 10 located on the east side (or west side) (step S101). In other words, the topology bypass information management unit 113 judges whether or not the topology bypass information is included in the overhead of the signal transmitted from another transmission apparatus 10 located on the east side (or west side).

As a result of the judgment in the step S101, if it is judged that the notice of the topology bypass information is not given (the step S101: No), it is considered that any transmission apparatus 10 has not started the operation of generating the topology bypass information. Therefore, in order that the self-transmission-apparatus 10 becomes a start trigger to generate the topology bypass information, the topology bypass information management unit 113 newly generates the topology bypass information which includes the apparatus ID of the self-transmission-apparatus 10 in a topology portion (step S106). At this time, if the self-transmission-apparatus 10 is the transmission apparatus 10 which terminates the bypass transmission line 30, the topology bypass information management unit 113 generates the topology bypass information which includes the apparatus ID of the transmission apparatus 10 located on the opposite side of the bypass transmission line 30 in a bypass portion, in association with the apparatus ID included in the topology portion.

Then, the topology bypass information management unit 113 gives notice of the generated topology bypass information to the west-side (or east-side) transmission apparatus 10 via the west-side signal transceiver 104 (or east-side signal transceiver 103) (step S106).

On the other hand, as a result of the judgment in the step S101, if it is judged that the notice of the topology bypass information is given (the step S101: Yes), then, the topology bypass information management unit 113 judges whether or not the notified topology bypass information includes the topology portion which includes the apparatus ID of the self-transmission-apparatus 10 (step S102).

As a result of the judgment in the step S102, if it is judged that the notified topology bypass information does not include the topology portion which includes the apparatus ID of the self-transmission-apparatus 10 (the step S102: No), it is considered that although the generating of the topology bypass information has been started by another transmission apparatus 10, information about the self-transmission-apparatus 10 has not been added. Therefore, the topology bypass information management unit 113 newly adds the apparatus ID of the self-transmission-apparatus 10 to the topology portion in the notified topology bypass information (step S103). At this time, if the self-transmission-apparatus 10 is the transmission apparatus 10 which terminates the bypass transmission line 30, the topology bypass information management unit 113 newly adds the apparatus ID of the transmission apparatus 10 located on the opposite side of the bypass transmission line 30 to the bypass portion, in association with the apparatus ID added to the topology portion. Then, the topology bypass information management unit 113 gives notice of the generated topology bypass information to the west-side (or east-side) transmission apparatus 10 via the west-side signal transceiver 104 (or east-side signal transceiver 103) (step S103).

On the other hand, as a result of the judgment in the step S102, if it is judged that the notified topology bypass information includes the topology portion which includes the apparatus ID of the self-transmission-apparatus 10 (the step S102: Yes), it is considered that the topology bypass information in which the information about the self-transmission-apparatus 10 has been already added (namely, the topology bypass information reflecting the information about all the transmission apparatuses 10) is transmitted on the ring transmission line 20. Therefore, the topology bypass information management unit 113 extracts and manages the notified topology bypass information (step S104). Moreover, the topology bypass information management unit 113 gives notice of the notified topology bypass information to the west-side (or east-side) transmission apparatus 10 as it is, via the west-side signal transceiver 104 (or east-side signal transceiver 103) (step S105). Incidentally, when there is a change in the connection aspect of the self-transmission-apparatus 10 at the stage in the step S104, the change in the connection aspect may be reflected in the notified topology bypass information. In this case, in the step S105, notice of the topology bypass information, in which the change in the connection aspect is reflected, is preferably given to the west-side (or east-side) transmission apparatus 10.

The operation of generating the topology bypass information explained above will be explained more specifically by using a specific example illustrated in FIG. 6. FIG. 6 are data structure diagrams illustrating one example of the topology bypass information.

As illustrated in FIG. 6A, such a transmission system 1 is exemplified that eight transmission apparatuses 10, each of which has respective one of apparatus IDs of “1” to “8”, are disposed on the ring transmission line 20 and that two transmission apparatuses 10 with apparatus IDs of “3” and “7” terminate the bypass transmission line 30.

Here, the transmission apparatus 10 with an apparatus ID of “2” (hereinafter, in the explanation, the transmission apparatus 10 with an apparatus ID of “X” is referred to as a “transmission apparatus 10#X” as occasion demands) is assumed to be a start trigger to generate the topology bypass information. In this case, the topology bypass information management unit 113 included in the transmission apparatus 10#2 newly adds the topology bypass information including the apparatus ID “2” of the self-transmission-apparatus 10#2 in the topology portion, as illustrated on the uppermost table of FIG. 6B. Moreover, the topology bypass information management unit 113 included in the transmission apparatus 10#2 sets the bypass portion, which corresponds to the apparatus ID “2” included in the topology portion, to be blank (or Null), as illustrated on the uppermost table of FIG. 6B, because the transmission apparatus 10#2 does not terminate the bypass transmission line 30. Then, the topology bypass information management unit 113 included in the transmission apparatus 10#2 gives notice of the topology bypass information illustrated on the uppermost table of FIG. 6B to the east-side transmission apparatus 10#3.

Then, the topology bypass information management unit 113 included in the transmission apparatus 10#3 newly adds the apparatus ID “3” of the self-transmission-apparatus 10#3 to the topology portion in the topology bypass information notified by the transmission apparatus 10#2, as illustrated on the second table of FIG. 6B. Moreover, the topology bypass information management unit 113 included in the transmission apparatus 10#3 adds the apparatus ID “7” of the transmission apparatus 10#7 located on the opposite side of the bypass transmission line 30, to the bypass portion which corresponds to the apparatus ID “3” included in the topology portion, as illustrated on the second table of FIG. 6B, because the transmission apparatus 10#3 terminates the bypass transmission line 30. Then, the topology bypass information management unit 113 included in the transmission apparatus 10#3 gives notice of the topology bypass information illustrated on the second table of FIG. 6B, to the east-side transmission apparatus 10#4.

The operation described above is also performed by each of the transmission apparatus 10#4 to transmission apparatus 10#8 and the transmission apparatus 10#1. As a result, the transmission apparatus 10#2, which is the start trigger to generate the topology bypass information, is notified of the topology bypass information illustrated on the lowermost table of FIG. 6B. Therefore, the topology bypass information management unit 113 included in the transmission apparatus 10#2 extracts and manages the topology bypass information illustrated on the lowermost table of FIG. 6B.

Incidentally, in the topology portion in the topology bypass information, the apparatus IDs of the transmission apparatuses 10 disposed on the ring transmission line 20 are arranged in such an order that the transmission apparatuses 10 are disposed on the ring transmission line 20. Moreover, in the head portion of the topology portion in the topology bypass information, the apparatus ID of the transmission apparatus 10 which extracts and manages the relevant topology bypass information is stored. For example, as illustrated on the lowermost table of FIG. 6B, in the head portion of the topology portion in the topology bypass information which is extracted and managed by the transmission apparatus 10#2, the apparatus ID “2” of the transmission apparatus 10#2 which extracts and manages the relevant topology bypass information is stored. In the same manner, as illustrated in FIG. 6C, in the head portion of the topology portion in the topology bypass information which is extracted and managed by the transmission apparatus 10#1, the apparatus ID “1” of the transmission apparatus 10#1 which extracts and manages the relevant topology bypass information is stored.

### (4-2) Operation of Generating and Transmitting APS Information

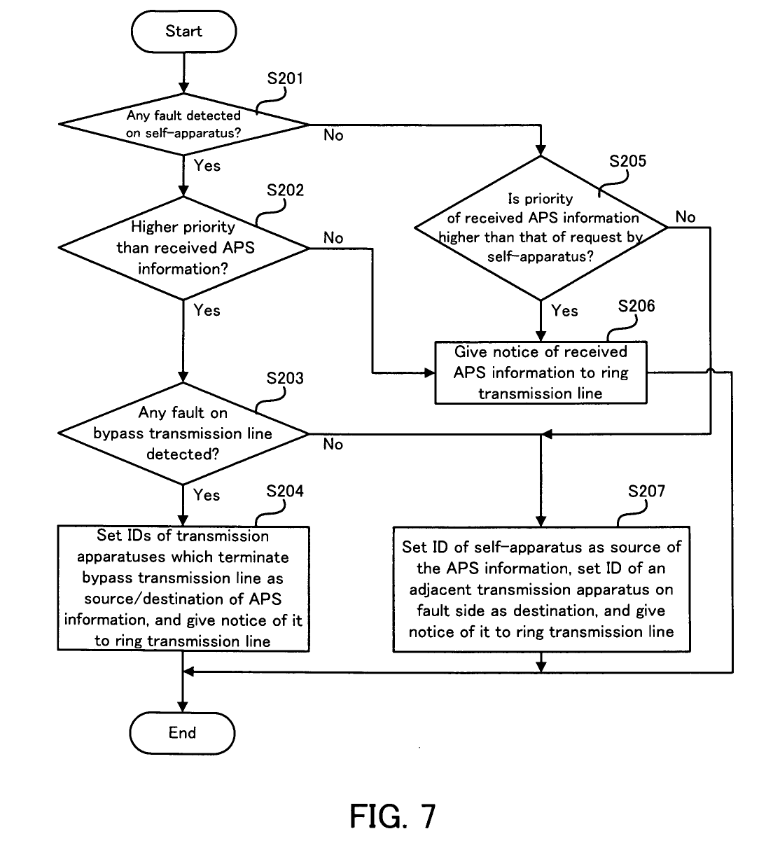

Next, with reference to FIG. 7, an explanation will be given on an operation of generating the APS information by the transmission apparatus 10 in the embodiment. FIG. 7 is a flowchart illustrating a flow of the operation of generating the APS information by the transmission apparatus 10 in the embodiment.

As illustrated in FIG. 7, the fault detector 121 judges whether or not a fault on the ring transmission line 20 or the bypass transmission line 30 is detected (step S201). In other words, the transmission apparatus 10 judges whether or not the self-transmission-apparatus 10 detects a fault on the ring transmission line 20 or the bypass transmission line 30.

As a result of the judgment in the step S201, if it is judged that the fault detector 121 has detected the fault (the step S201: Yes), then, the APS information generator 122 judges whether or not the priority of the fault detected in the step S201 is higher than the priority of the APS information received from another transmissions apparatus 10 so far (step S202). Incidentally, this judgment may be performed by comparing the type of the fault (e.g. a SF (Signal Failure), a SD (Signal Deterioration), and the like) detected in the step S201 with the type of a change request (e.g. a SF (Signal Failure), a SD (Signal Deterioration), and the like) included in the APS information.

As a result of the judgment in the step S202, if it is judged that the priority of the fault detected in the step S201 is higher (the step S202: Yes), then, the fault detector 121 judges whether or not the fault detected in the step S201 is a fault on the bypass transmission line 30 (step S203). Incidentally, the judgment in the step S203 may be performed in a case where the self-transmission-apparatus 10 detects the fault, and the self-transmission-apparatus 10 recognizes whether or not the self-transmission apparatus 10 terminates the bypass transmission line 30. Therefore, the judgment operation in the step S203 may be performed without requiring special information.

As a result of the judgment in the step S203, if it is judged that the fault detected in the step S201 is the fault on the bypass transmission line 30 (the step S203: Yes), the APS information generator 122 generates the APS information in which the apparatus IDs of the two transmission apparatuses 10 which terminate the bypass transmission line 30 are set as a source and a destination (step S204). Then, the APS information generator 122 gives notice of the generated APS information to another transmission apparatus 10 via the east-side signal transceiver 103 or the west-side signal transceiver 104 (step S204). Then, the transmission apparatus 10 may end the operation or may repeat the operations after the step S201.

On the other hand, as a result of the judgment in the step S203, if it is judged that the fault detected in the step S201 is not the fault on the bypass transmission line 30 (the step S203: No), the APS information generator 122 generates the APS information in which the apparatus ID of the self-transmission-apparatus 10 is set as the source and in which the apparatus ID of another transmission apparatus 10 adjacent via the ring transmission line 20 with the fault detected is set as the destination (step S207). Then, the APS information generator 122 gives notice of the generated APS information to another transmission apparatus 10 via the east-side signal transceiver 103 or the west-side signal transceiver 104 (step S207). Then, the transmission apparatus 10 may end the operation or may repeat the operations after the step S201.

On the other hand, as a result of the judgment in the step S202, if it is judged that the priority of the fault detected in the step S201 is not higher (the step S202: No), the APS information generator 122 gives notice of the APS information received so far (i.e. the existing APS information having a higher priority than that of the fault detected this time) to another transmission apparatus 10 via the east-side signal transceiver 103 or the west-side signal transceiver 104 (step S206). Then, the transmission apparatus 10 may end the operation or may repeat the operations after the step S201.

On the other hand, as a result of the judgment in the step S201, if it is judged that the fault detector 121 has not detected the fault (the step S201: No), then, the APS information generator 122 judges whether or not the priority of the APS information received from another transmission apparatus 10 so far is higher than the priority of the change request for the transmission route requested by the self-transmission-apparatus 10 (in other words, the change request for the transmission route spontaneously and independently requested from the occurrence of the fault) (step S205). Incidentally, the judgment in the step S205 may not be performed if there is no change request for the transmission route requested by the self-transmission-apparatus 10.

As a result of the judgment in the step S205, if it is judged that the priority of the APS information received from another transmission apparatus 10 so far is higher (the step S205: Yes), the APS information generator 122 gives notice of the APS information received so far (i.e. the existing APS information having a higher priority than that of the change request requested by the self-transmission-apparatus 10 this time) to another transmission apparatus 10 via the east-side signal transceiver 103 or the west-side signal transceiver 104 (the step S206). Then, the transmission apparatus 10 may end the operation or may repeat the operations after the step S201.

On the other hand, as a result of the judgment in the step S205, if it is judged that the priority of the APS information received from another transmission apparatus 10 so far is not higher (the step S205: No), the APS information generator 122 generates the APS information in which the apparatus ID of the self-transmission-apparatus 10 is set as the source and in which the apparatus ID of another transmission apparatus 10 adjacent via the ring transmission line 20 with the fault detected is set as the destination (the step S207). Then, the APS information generator 122 gives notice of the generated APS information to another transmission apparatus 10 via the east-side signal transceiver 103 or the west-side signal transceiver 104 (the step S207). Then, the transmission apparatus 10 may end the operation or may repeat the operations after the step S201.

### (4-3) Operation of Changing Transmission Route

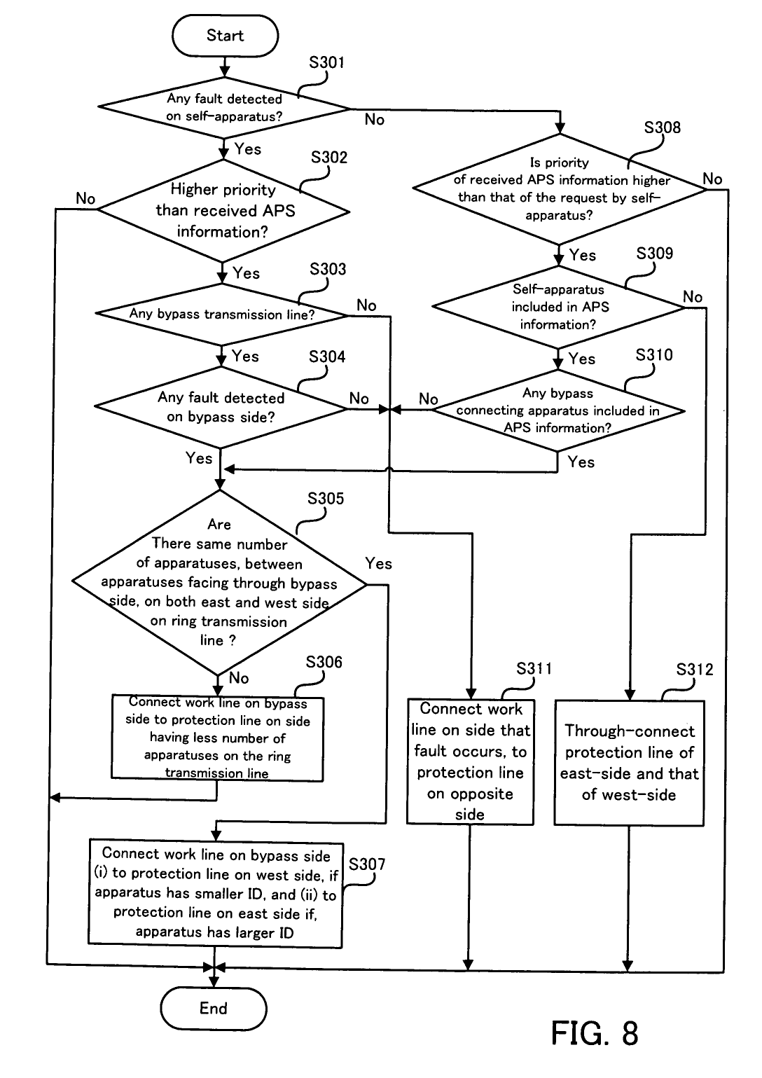

Next, with reference to FIG. 8, an explanation will be given on an operation of changing the transmission route by the transmission apparatus 10 in the embodiment. FIG. 8 is a flowchart illustrating a flow of the operation of changing the transmission route by the transmission apparatus 10 in the embodiment.

As illustrated in FIG. 8, the fault detector 121 judges whether or not a fault on the ring transmission line 20 or the bypass transmission line 30 is detected (step S301). In other words, the transmission apparatus 10 judges whether or not the self-transmission-apparatus 10 detects a fault on the ring transmission line 20 or the bypass transmission line 30.

As a result of the judgment in the step S301, if it is judged that the fault detector 121 has detected the fault (the step S301: Yes), then, the APS information generator 122 judges whether or not the priority of the fault detected in the step S301 is higher than the priority of the APS information received from another transmissions apparatus 10 so far (step S302). Incidentally, this judgment may be performed by comparing the type of the fault (e.g. a SF (Signal Failure), a SD (Signal Deterioration), and the like) detected in the step S301 with the type of the change request (e.g. a SF (Signal Failure), a SD (Signal Deterioration), and the like) included in the APS information.

As a result of the judgment in the step S302, if it is judged that the priority of the fault detected in the step S301 is higher (the step S302: Yes), then, the rescue route judgment unit 130 judges whether or not the self-transmission-apparatus 10 terminates the bypass transmission line 30 (step S303). Incidentally, the judgment in the step S303 is performed in a case where the self-transmission-apparatus 10 detects the fault, and the self-transmission-apparatus 10 recognizes whether or not the self-transmission-apparatus 10 terminates the bypass transmission line 30. Therefore, the judgment operation in the step S303 may be performed without requiring special information. Alternatively, the judgment in the step S303 may be performed on the basis of whether or not the apparatus ID of the self-transmission-apparatus 10 is included in bypass portion in the topology bypass information managed by the topology bypass information management unit 113. In this case, if the apparatus ID of the self-transmission-apparatus 10 is included in the bypass portion in the topology bypass information, it is judged that the self-transmission-apparatus 10 terminates the bypass transmission line 30.

As a result of the judgment in the step S303, if it is judged that the self-transmission-apparatus 10 terminates the bypass transmission line 30 (the step S303: Yes), then, the rescue route judgment unit 130 judges whether or not the fault detected in the step S301 is a fault on the bypass transmission line 30 (step S304). Incidentally, the judgment in the step S304 is performed in a case where the self-transmission-apparatus 10 detects the fault, and the self-transmission-apparatus 10 recognizes whether or not the self-transmission-apparatus 10 terminates the bypass transmission line 30. Therefore, the judgment operation in the step S304 may be performed without requiring special information.

As a result of the judgment in the step S304, if it is judged that the fault detected in the step S301 is the fault on the bypass transmission line 30 (the step S304: Yes), it is considered that the fault occurs on the bypass transmission line 30 terminated by the self-transmission-apparatus 10. In this case, the rescue route judgment unit 130 judges whether or not the number of the transmission apparatuses 10 which exist on the east side of the ring transmission line 20 between the self-transmission-apparatus 10 and the other transmission apparatus 10 located on the opposite side of the bypass transmission line 30 is same as the number of the transmission apparatuses 10 which exist on the west side of the ring transmission line 20 between the self-transmission-apparatus 10 and the other transmission apparatus 10 located on the opposite side of the bypass transmission line 30 (step S305).

As a result of the judgment in the step S305, if it is judged that the number of the transmission apparatuses 10 which exist on the east side between the self-transmission-apparatus 10 and the other transmission apparatus 10 located on the opposite side of the bypass transmission line 30 is not same as the number of the transmission apparatuses 10 which exist on the west side between the self-transmission-apparatus 10 and the other transmission apparatus 10 located on the opposite side of the bypass transmission line 30 (the step S305: No), the rescue route judgment unit 130 controls the work line connector 140 and the protection line connector 150 so as to connect the work line on the bypass side to the protection line 22 of the ring transmission line 20 on the side having the less number of the transmission apparatuses 10 which exist on the ring transmission line 20 between the self-transmission-apparatus 10 and the other transmission apparatus 10 located on the opposite side of the bypass transmission line 30, out of the east side and the west side (step S306). Then, the transmission apparatus 10 may end the operation or may repeat the operations after the step S301.

On the other hand, as a result of the judgment in the step S305, if it is judged that the number of the transmission apparatuses 10 which exist on the east side between the self-transmission-apparatus 10 and the other transmission apparatus 10 located on the opposite side of the bypass transmission line 30 is same as the number of the transmission apparatuses 10 which exist on the west side between the self-transmission-apparatus 10 and the other transmission apparatus 10 located on the opposite side of the bypass transmission line 30 (the step S305: Yes), the rescue route judgment unit 130 compares the apparatus ID of the self-transmission-apparatus 10 with the apparatus ID other transmission apparatus 10 located on the opposite side of the bypass transmission line 30. As a result of the comparison, if the apparatus ID of the self-transmission-apparatus 10 is smaller than the apparatus ID of the other transmission apparatus 10 located on the opposite side of the bypass transmission line 30, the rescue route judgment unit 130 controls the work line connector 140 and the protection line connector 150 so as to connect the work line on the bypass side to the protection line 22 of the ring transmission line 20 on the west side (step S307). On the other hand, if the apparatus ID of the self-transmission-apparatus 10 is not smaller than the apparatus ID of the other transmission apparatus 10 located on the opposite side of the bypass transmission line 30, the rescue route judgment unit 130 controls the work line connector 140 and the protection line connector 150 so as to connect the work line on the bypass side to the protection line 22 of the ring transmission line 20 on the east side (step S307). Then, the transmission apparatus 10 may end the operation or may repeat the operations after the step S301.

On the other hand, as a result of the judgment in the step S304, if it is judged that the fault detected in the step S301 is not the fault on the bypass transmission line 30 (the step S304: No), it is considered that the fault occurs on the ring transmission line 20 terminated by the self-transmission-apparatus 10. Therefore, the rescue route judgment unit 130 changes the transmission route in the same manner as the BLSR (Bidirectional Line Switch Ring). Specifically, the rescue route judgment unit 130 controls the work line connector 140 and the protection line connector 150 so as to connect the work line 21 on the ring transmission line 20 on the side that the fault occurs out of the east side and the west side, to the protection line 22 of the ring transmission line 20 on the side (i.e. the opposite side) that the fault does not occur out of the east side and the west side (step S311). Then, the transmission apparatus 10 may end the operation or may repeat the operations after the step S301.

On the other hand, as a result of the judgment in the step S303, if it is judged that the self-transmission-apparatus 10 does not terminate the bypass transmission line 30 (the step S303: No), it is considered that the fault occurs on the ring transmission line 20 terminated by the self-transmission-apparatus 10. Therefore, the rescue route judgment unit 130 changes the transmission route in the same manner as the BLSR (Bidirectional Line Switch Ring). Then, the transmission apparatus 10 may end the operation or may repeat the operations after the step S301.

On the other hand, as a result of the judgment in the step S302, if it is judged that the priority of the fault detected in the step S301 is not higher (the step S302: No), the transmission apparatus 10 ends the operation without changing the transmission route. Alternatively, the transmission apparatus 10 may repeat the operations after the step S301 without changing the transmission route.

On the other hand, as a result of the judgment in the step S301, if it is judged that the fault detector 121 has not detected the fault (the step S301: No), then, the APS information generator 122 judges whether or not the priority of the APS information received from another transmission apparatus 10 so far is higher than the priority of the change request for the transmission route requested by the self-transmission-apparatus 10 (in other words, the change request for the transmission route spontaneously and independently requested from the occurrence of the fault) (step S308). Incidentally, the judgment in the step S308 may not be performed if there is no change request for the transmission route requested by the self-transmission-apparatus 10.

As a result of the judgment in the step S308, if it is judged that the priority of the APS information received from another transmission apparatus 10 so far is higher (the step S308: Yes), the rescue route judgment unit 130 judges whether or not the apparatus ID of the self-transmission-apparatus 10 is included in the APS information (i.e. the existing APS information having a higher priority than that of the change request requested by the self-transmission-apparatus 10 this time) (step S309).

As a result of the judgment in the step S309, if it is judged that the apparatus ID of the self-transmission-apparatus 10 is included in the APS information (the step S309: Yes), then, the rescue route judgment unit 130 judges whether or not the apparatus ID of the transmission apparatus 10 which terminates the bypass transmission line 30 is included in the APS information (step S310). The judgment in the step S301 may be performed, for example, by comparing the apparatus ID included in the APS information with the apparatus ID included in the bypass portion in the topology bypass information managed by the topology bypass information management unit 113. In this case, if the apparatus ID included in the APS information matches the apparatus ID included in the bypass portion in the topology bypass information, it is judged that the apparatus ID of the transmission apparatus 10 which terminates the bypass transmission line 30 is included in the APS information.

As a result of the judgment in the step S310, if it is judged that the apparatus ID of the transmission apparatus 10 which terminates the bypass transmission line 30 is included in the APS information (the step S310: Yes), it is considered that the fault occurs on the bypass transmission line 30 terminated by the self-transmission-apparatus 10. Therefore, the rescue route judgment unit 130 judges whether or not the number of the transmission apparatuses 10 which exist on the east side of the ring transmission line 20 between the self-transmission-apparatus 10 and the other transmission apparatus 10 located on the opposite side of the bypass transmission line 30 is same as the number of the transmission apparatuses 10 which exist on the west side of the ring transmission line 20 between the self-transmission-apparatus 10 and the other transmission apparatus 10 located on the opposite side of the bypass transmission line 30 (the step S305). Then, depending on the judgment result in the step S305, the rescue route judgment unit 130 controls the work line connector 140 and the protection line connector 150 so as to connect the work line on the bypass side to the protection line 22 of the ring transmission line 20 on the side having the less number of the transmission apparatuses 10 which exist on the ring transmission line 20 between the self-transmission-apparatus 10 and the other transmission apparatus 10 located on the opposite side of the bypass transmission line 30, out of the east side and the west side (step S306). Alternatively, depending on the judgment result in the step S305 and the relation between the apparatus IDs of the two transmission apparatuses 10 which terminates the bypass transmission line 30, the rescue route judgment unit 130 controls the work line connector 140 and the protection line connector 150 so as to connect the work line on the bypass side to the protection line 22 of the ring transmission line 20 on any one of the east side and the west side (the step S307).

On the other hand, as a result of the judgment in the step S310, if it is judged that the apparatus ID of the transmission apparatus 10 which terminates the bypass transmission line 30 is not included in the APS information (the step S310: No), it is considered that the fault occurs on the ring transmission line 20 terminated by the self-transmission-apparatus 10. The rescue route judgment unit 130 changes the transmission route in the same manner as the BLSR (Bidirectional Line Switch Ring) (the step S311). Then, the transmission apparatus 10 may end the operation or may repeat the operations after the step S301.

On the other hand, as a result of the judgment in the step S309, if it is judged that the apparatus ID of the self-transmission-apparatus 10 is not included in the APS information (the step S309: No), it is considered that the fault occurs on the ring transmission line 20 terminated by another transmission apparatus 10. Therefore, the rescue route judgment unit 130 changes the transmission route in the same manner as the BLSR (Bidirectional Line Switch Ring). Specifically, the rescue route judgment unit 130 controls the work line connector 140 and the protection line connector 150 so as to through-connect the protection line 22 of the ring transmission line 20 on the east side and the protection line 22 of the ring transmission line 20 on the west side (step S312). Then, the transmission apparatus 10 may end the operation or may repeat the operations after the step S301.

On the other hand, as a result of the judgment in the step S308, if it is judged that the priority of the APS information received from another transmission apparatus 10 so far is not higher (the step S308: No), the transmission apparatus 10 ends the operation without changing the transmission route. Alternatively, the transmission apparatus 10 may repeat the operations after the step S301 without changing the transmission route.

### (5) Specific Examples

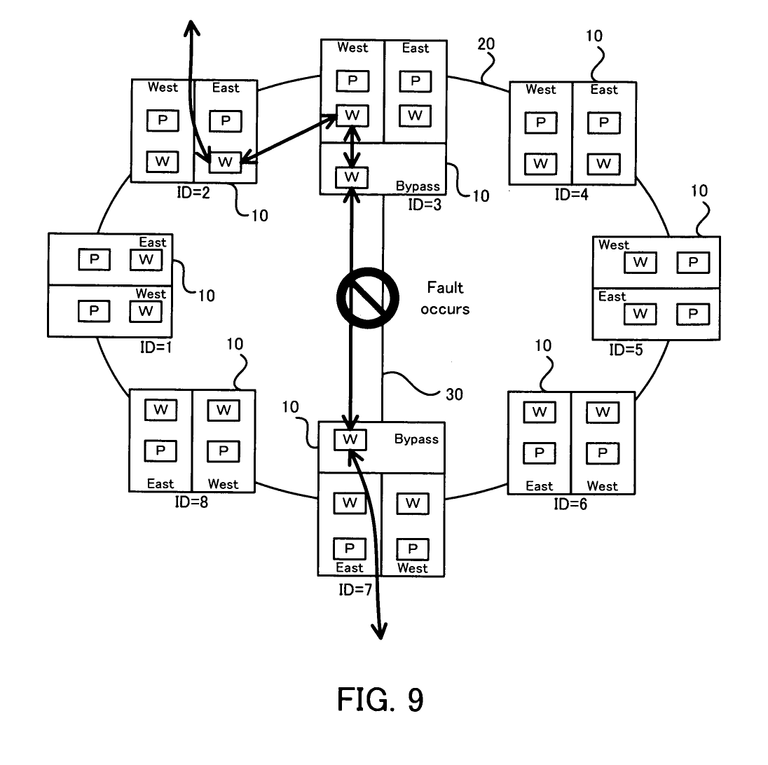

Next, with reference to FIG. 9 to FIG. 17, an explanation will be given on specific examples of the operation of changing the transmission route by the transmission apparatus 10 in the embodiment described above.

### (5-1) First Specific Example

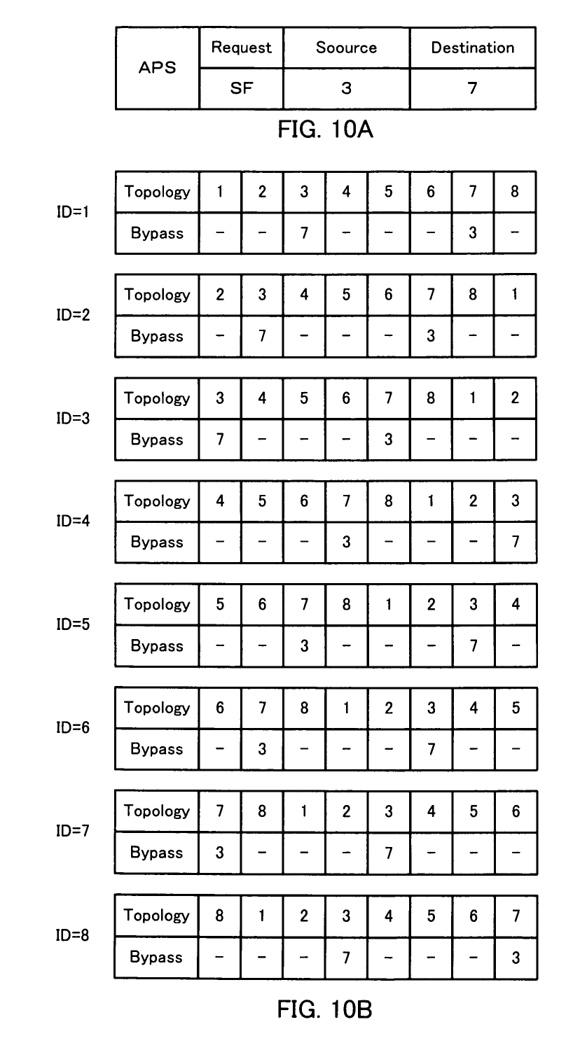

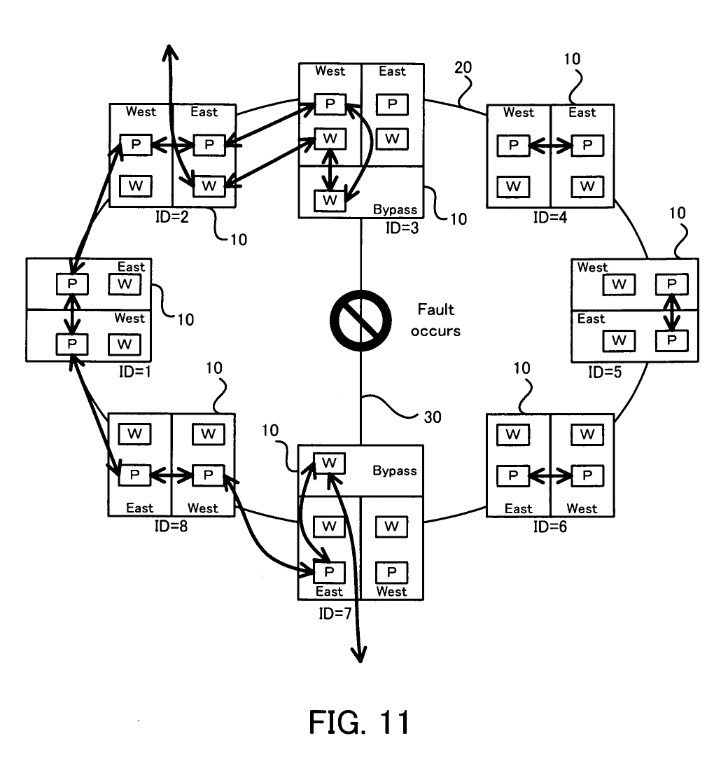

Firstly, with reference to FIG. 9 to FIG. 11, an explanation will be given on a first specific example of the operation of changing the transmission route by the transmission apparatus 10 in the embodiment. FIG. 9 is a schematic diagram illustrating the state of the transmission system 1 before the operation of changing the transmission route in the first specific example. FIG. 10 are data structure diagrams illustrating one example of the APS information and the topology bypass information generated by the operation of changing the transmission route in the first specific example. FIG. 11 is a schematic diagram illustrating the state of the transmission system 1 after the operation of changing the transmission route in the first specific example.

As illustrated in FIG. 9, the explanation will be given by using an example in which a not-illustrated first terminal apparatus, which is connected to the transmission apparatus 10#2, and a not-illustrated second terminal apparatus, which is connected to the transmission apparatus 10#7, transmit and receive a signal via the transmission apparatus 10#2, the transmission apparatus 10#3, the transmission apparatus 10#7, the work line 21 of the ring transmission line 20 and the bypass transmission line 30. Here, as illustrated in FIG. 9, it is assumed that a fault occurs on the bypass transmission line 30 and that the transmission apparatus 10#3 detects the fault. Incidentally, in FIG. 9 (and similar drawings described later), “W” indicates the work line (Work), and “P” indicates the protection line (Protection). Moreover, in FIG. 9 (and similar drawings described later), a relatively thick bidirectional line indicates a signal flow.

In this case, the transmission apparatus 10#3 generates the APS information in accordance with the operation example illustrated in FIG. 7. Specifically, on the transmission apparatus 10#3, it is judged that the self-transmission-apparatus 10#3 has detected the fault (the step S201 in FIG. 7: Yes), it is judged that the priority of the detected fault is higher (the step S202 in FIG. 7: Yes), and it is judged that the detected fault is the fault on the bypass transmission line 30 (the step S203 in FIG. 7: Yes). Therefore, the transmission apparatus 10#3 generates the APS information in which the apparatus ID “3” of the transmission apparatus 10#3 which is one of the transmission apparatuses that terminate the bypass transmission line 30 is set as the source and in which the apparatus ID “7” of the transmission apparatus 10#7 which is the other one of the transmission apparatus that terminates the bypass transmission line 30 is set as the destination, as illustrated in FIG. 10A (the step S204 in FIG. 7). Incidentally, the APS information may include the type of the change request, in addition to the source and the destination. The example illustrated in FIG. 10A exemplifies that the type of the change request is “SF”.

Then, the transmission apparatus 10#3 gives notice of the generated APS information to the transmission apparatus 10#4 on the east side via the ring transmission line 20. On the transmission apparatus 10#4, it is judged that the self-transmission-apparatus 10#4 has not detected the fault on the bypass transmission line 30 (the step S201 in FIG. 7: No), and it is judged that the priority of the APS information received from the transmission apparatus 10#3 is higher (the step S205 in FIG. 7: Yes). Therefore, the transmission apparatus 10#4 further gives notice of the received APS information to the transmission apparatus 10#5 on the east side. Such operations are also performed by the transmission apparatuses 10#1, 10#2 and 10#5 to 10#8. As a result, any of the transmission apparatuses 10#1 to 10#8 is notified of the APS information illustrated in FIG. 10A.

Moreover, the topology bypass information managed by the respective topology bypass information management units 113 of the transmission apparatuses 10#1 to 10#8 in the state illustrated in FIG. 9 is as illustrated in FIG. 10B. Incidentally, FIG. 10B illustrates the topology bypass information managed by the respective topology bypass information management units 113 of the transmission apparatuses 10#1 to 10#8, in order from the top. By referring to the topology bypass information, the transmission apparatus 10 which does not detect the fault (in other words, the transmission apparatus 10 which does not generate the APS information) can preferably judge whether or not the apparatus ID of the transmission apparatus 10 which terminates the bypass transmission line 30 is included in the APS information.

Then, the transmission apparatus 10#3 changes the transmission route in accordance with the operation example illustrated in FIG. 8. Specifically, on the transmission apparatus 10#3, it is judged that the self-transmission-apparatus 10#3 has detected the fault (the step S301 in FIG. 8: Yes), it is judged that the priority of the detected fault is higher (the step S302 in FIG. 8: Yes), it is judged that the self-transmission-apparatus 10#3 terminates the bypass transmission line 30 (the step S303 in FIG. 8: Yes), it is judged that the detected fault is the fault on the bypass transmission line 30 (the step S304 in FIG. 8: Yes), and it is judged that the number of the transmission apparatuses 10 which exist on the east side of the ring transmission line 20 between the two transmission apparatuses 10#3 and 10#7 which terminate the bypass transmission line 30 is same as the number of the transmission apparatuses 10 which exist on the west side of the ring transmission line 20 between the two transmission apparatuses 10#3 and 10#7 which terminate the bypass transmission line 30 (specifically, both numbers are 3) (the step S305 in FIG. 8: Yes). Therefore, as illustrated in FIG. 11, the transmission apparatus 10#3 having the smaller apparatus ID than that of the transmission apparatus 10#7 connects the work line on the bypass side to the protection line 22 of the ring transmission line 20 on the west side.

On the other hand, on the transmission apparatus 10#7 located on the opposite side of the bypass transmission line 30, it is judged that the self-transmission-apparatus 10#7 has not detected the fault (the step S301 in FIG. 8: No), it is judged that the priority of the received APS information is higher (the step S308 in FIG. 8: Yes), it is judged that the apparatus ID of the transmission apparatus 10#7 is included in the APS information (the step S309 in FIG. 8: Yes), it is judged that the apparatus IDs of the transmission apparatuses 10#3 and 10#7 which terminate the bypass transmission line 30 are included in the APS information (the step S310 in FIG. 8: Yes), and it is judged that the number of the transmission apparatuses 10 which exist on the east side of the ring transmission line 20 between the two transmission apparatuses 10#3 and 10#7 which terminate the bypass transmission line 30 is same as the number of the transmission apparatuses 10 which exist on the west side of the ring transmission line 20 between the two transmission apparatuses 10#3 and 10#7 which terminate the bypass transmission line 30 (specifically, both numbers are 3) (the step S305 in FIG. 8: Yes). Therefore, as illustrated in FIG. 11, the transmission apparatus 10#7 having the larger apparatus ID than that of the transmission apparatus 10#3 connects the work line on the bypass side to the protection line 22 of the ring transmission line 20 on the east side.

On the other hand, on the transmission apparatuses 10#1, 10#2, 10#4 to 10#6 and 10#8 which do not terminate the bypass transmission line 30, it is judged that the self-transmission-apparatus 10#1, 10#2, 10#4 to 10#6 or 10#8 has not detect the fault (the step S301 in FIG. 8: No), it is judged that the priority of the received APS information is higher (the step S308 in FIG. 8: Yes), and it is judged that the apparatus ID of the self-transmission-apparatus 10#1, 10#2, 10#4 to 10#6 or 10#8 is not included in the APS information (the step S309 in FIG. 8: No). Therefore, as illustrated in FIG. 11, each of the transmission apparatuses 10#1, 10#2, 10#4 to 10#6 and 10#8 through-connects the protection line 22 of the ring transmission line 20 on the east side with the protection line 22 of the ring transmission line 20 on the west side.

By this, as illustrated in FIG. 11, the transmission route via the bypass transmission line 30 between the transmission apparatus 10#2 and the transmission apparatus 10#7 is rescued by using the protection line 22 of the ring transmission line 20.

### (5-2) Second Specific Example

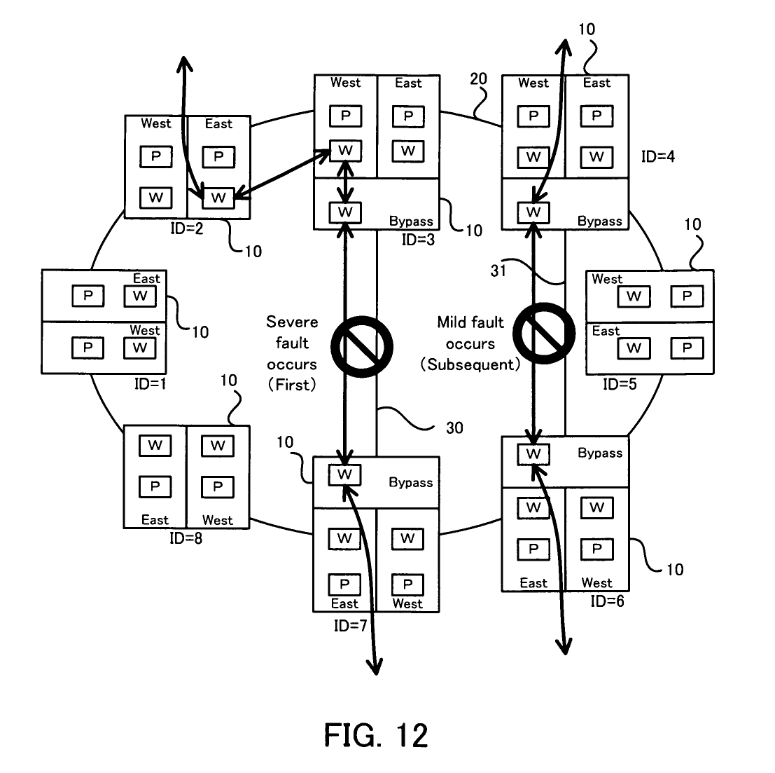

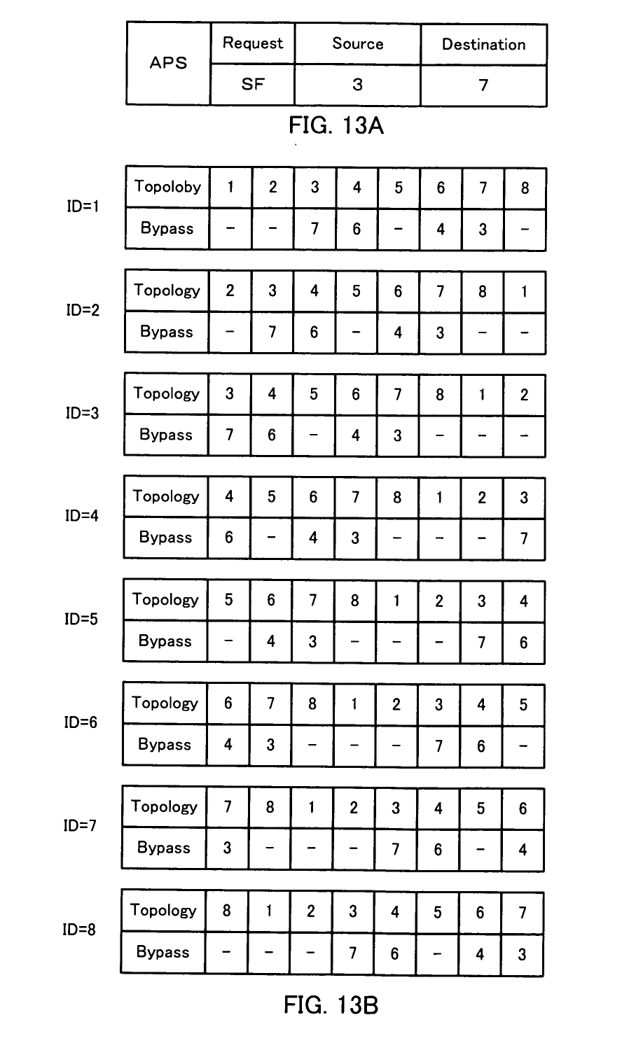

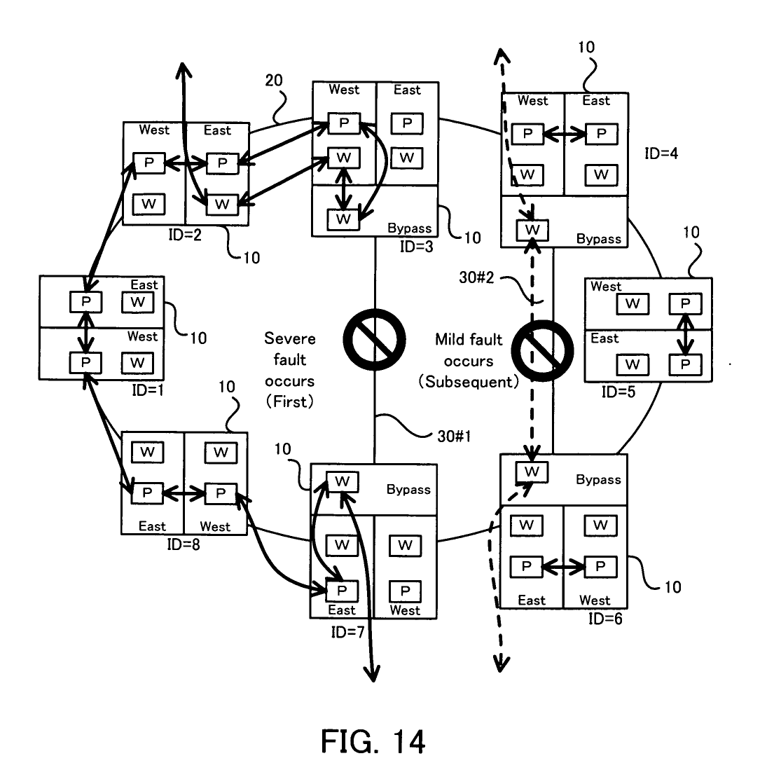

Next, with reference to FIG. 12 to FIG. 14, an explanation will be given on a second specific example of the operation of changing the transmission route by the transmission apparatus 10 in the embodiment. FIG. 12 is a schematic diagram illustrating the state of the transmission system 1 before the operation of changing the transmission route in the second specific example. FIG. 13 is a data structure diagram illustrating one example of the APS information and the topology bypass information generated by the operation of changing the transmission route in the second specific example. FIG. 14 is a schematic diagram illustrating the state of the transmission system 1 after the operation of changing the transmission route in the second specific example.

As illustrated in FIG. 12, the explanation will be given by using an example in which a bypass transmission line 31 terminated by the transmission apparatus 10#4 and the transmission apparatus 10#6 is further added to the transmission system 1 illustrated in FIG. 9 and in which a not-illustrated third terminal apparatus, which is connected to the transmission apparatus 10#4, and a not-illustrated fourth terminal apparatus, which is connected to the transmission apparatus 10#6, transmit and receive a signal via the transmission apparatus 10#4, the transmission apparatus 10#6, and the bypass transmission line 31. Here, as illustrated in FIG. 12, it is assumed that a relatively severe fault firstly occurs on the bypass transmission line 30 and that the transmission apparatus 10#3 detects the fault on the bypass transmission line 30. At the same time, it is assumed that a relatively mild fault subsequently occurs on the bypass transmission line 31 and that the transmission apparatus 10#6 detects the fault on the bypass transmission line 31.

For the fault on the bypass transmission line 30 which firstly occurs, the same operations as those explained by using FIG. 9 to FIG. 11 are performed. As a result, as illustrated in FIG. 14, the transmission route via the bypass transmission line 30 between the transmission apparatus 10#2 and the transmission apparatus 10#7 is rescued by the protection line 22 of the ring transmission line 20.

Then, when a new fault occurs on the bypass transmission line 31, the transmission apparatus 10#6 generates the APS information in accordance with the operation example illustrated in FIG. 7. Specifically, on the transmission apparatus 10#6, it is judged that the self-transmission-apparatus 10#6 has detected the fault (the step S201 in FIG. 7: Yes), and it is judged that the priority of the detected fault detected is lower (the step S202 in FIG. 7: No). Therefore, the transmission apparatus 10#6 gives notice of the APS information about the fault on the bypass transmission line 30 which firstly occurs (in other words, the APS information having a higher priority, notice of which has been already given from the transmission apparatus 10#3) to the transmission apparatus 10#7 on the east side via the ring transmission line 20, as illustrated in FIG. 13A. On the transmission apparatus 10#7, it is judged that the self-transmission-apparatus 10#7 has not detected the fault (the step S201 in FIG. 7: No), and it is judged that the priority of the APS information received from the transmission apparatus 10#6 (in other words, the APS information having a higher priority, notice of which has been already given from the transmission apparatus 10#3) is higher (the step S205 in FIG. 7: Yes). Therefore, the transmission apparatus 10#7 further gives notice of the received APS information to the transmission apparatus 10#8 on the east side. Such operations are also performed by the transmission apparatuses 10#8 and 10#1 to 10#5. As a result, any of the transmission apparatuses 10#1 to 10#8 is notified of the APS information illustrated in FIG. 13A. In other words, any of the transmission apparatuses 10#1 to 10#8 is not notified of the APS information reflecting the relatively mild fault which occurs on the bypass transmission line 31 after the occurrence of the fault on the bypass transmission line 30.

Therefore, as illustrated in FIG. 14, even if the relatively mild fault occurs on the bypass transmission line 31 after the occurrence of the fault on the bypass transmission line 30, the transmission route via the bypass transmission line 31 between the transmission apparatuses 10#4 and 10#6 is not rescued by using the protection line 22 of the ring transmission line 20.

### (5-3) Third Specific Example

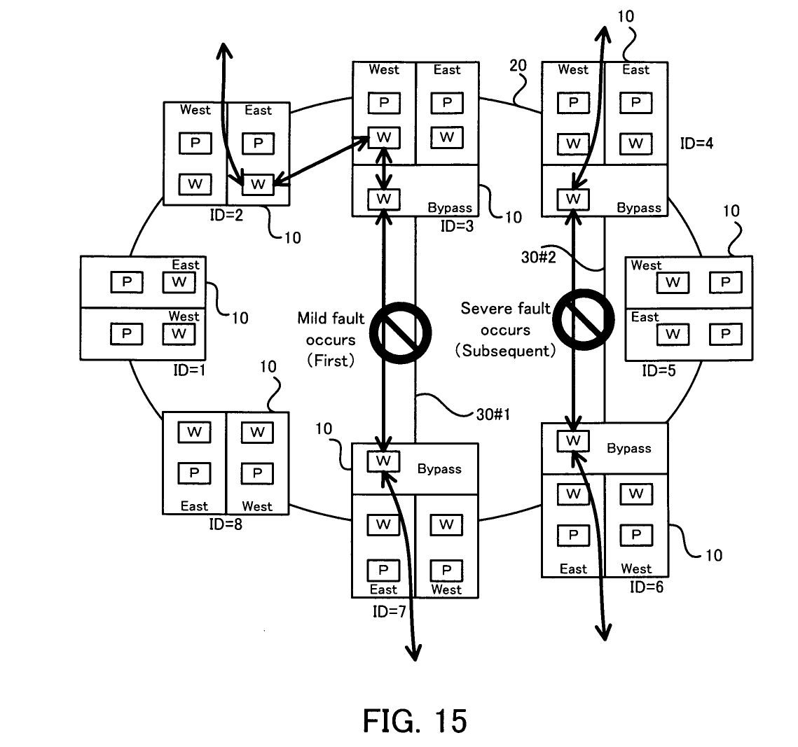

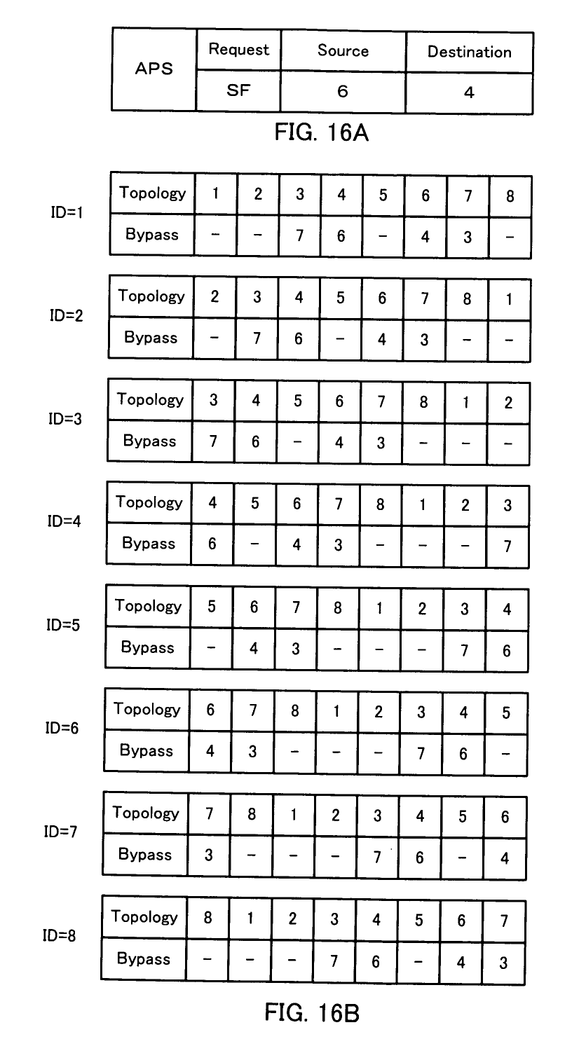

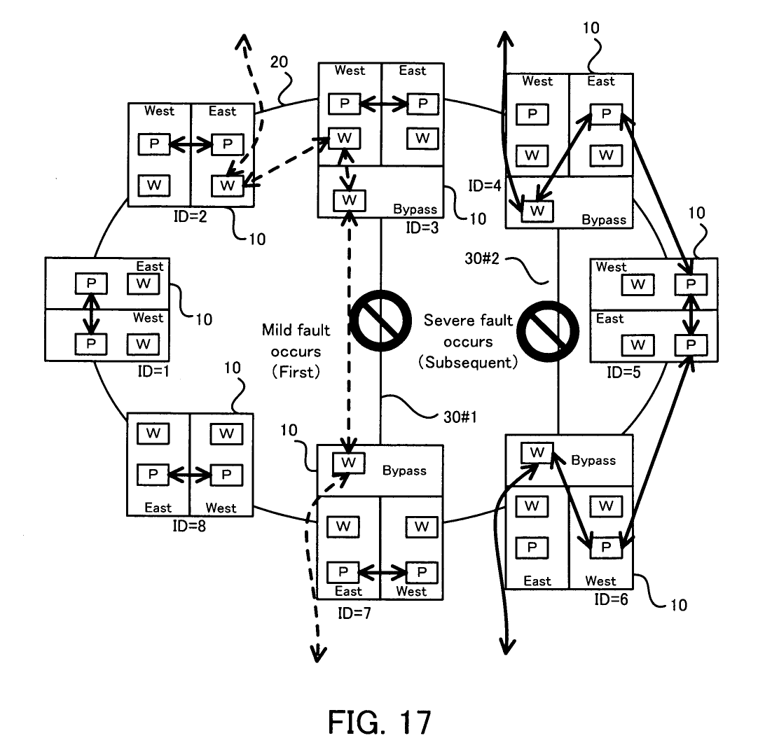

Next, with reference to FIG. 15 to FIG. 17, an explanation will be given on a third specific example of the operation of changing the transmission route by the transmission apparatus 10 in the embodiment. FIG. 15 is a schematic diagram illustrating the state of the transmission system 1 before the operation of changing the transmission route in a third specific example. FIG. 16 are data structure diagrams illustrating one example of the APS information and the topology bypass information generated by the operation of changing the transmission route in the third specific example. FIG. 17 is a schematic diagram illustrating the state of the transmission system 1 after the operation of changing the transmission route in the third specific example.

As illustrated in FIG. 15, the explanation will be given on an example in which a relatively mild fault firstly occurs on the bypass transmission line 30 and the transmission apparatus 10#3 detects the fault on the bypass transmission line 30, and in which a relatively severe fault subsequently occurs on the bypass transmission line 31 and the transmission apparatus 10#6 detects the fault on the bypass transmission line 31, in the transmission system 1 illustrated in FIG. 12.

For the fault on the bypass transmission line 30 which firstly occurs, the same operations as those explained by using FIG. 9 to FIG. 11 are performed. As a result, as illustrated in FIG. 17, the transmission route via the bypass transmission line 30 between the transmission apparatus 10#2 and the transmission apparatus 10#7 is rescued by the protection line 22 of the ring transmission line 20.

Then, if a new fault occurs on the bypass transmission line 31, the transmission apparatus 10#6 generates the APS information in accordance with the operation example illustrated in FIG. 7. Specifically, on the transmission apparatus 10#6, it is judged that the self-transmission-apparatus 10#6 has detected the fault (the step S201 in FIG. 7: Yes), it is judged that the priority of the detected fault detected is higher (the step S202 in FIG. 7: Yes), and it is judged that the detected fault is the fault on the bypass transmission line 31 (the step S203 in FIG. 7: Yes). Therefore, the transmission apparatus 10#6 generates the APS information in which the apparatus ID “6” of the transmission apparatus 10#6 which is one of the transmission apparatuses that terminate the bypass transmission line 31 is set as the source and in which the apparatus ID “4” of the transmission apparatus 10#4 which is the other one of the transmission apparatus that terminates the bypass transmission line 31 is set as the destination, as illustrated in FIG. 16A (the step S204 in FIG. 7).

Then, the transmission apparatus 10#6 gives notice of the generated APS information to the transmission apparatus 10#7 on the east side via the ring transmission line 20. On the transmission apparatus 10#7, it is judged that the self-transmission-apparatus 10#7 has not detected the fault on the bypass transmission line 31 (the step S201 in FIG. 7: No), and it is judged that the priority of the APS information received from the transmission apparatus 10#6 is higher (the step S205 in FIG. 7: Yes). Therefore, the transmission apparatus 10#7 further gives notice of the received APS information to the transmission apparatus 10#8 on the east side. Such operations are also performed by the transmission apparatuses 10#8 and 10#1 to 10#5. As a result, any of the transmission apparatuses 10#1 to 10#8 is notified of the APS information illustrated in FIG. 16A.

Moreover, the topology bypass information managed by the respective topology bypass information management units 113 of the transmission apparatuses 10#1 to 10#8 in the state illustrated in FIG. 15 is as illustrated in FIG. 16B. By referring to the topology bypass information, the transmission apparatus 10 which does not detect the fault (in other words, which does not make the APS information) can preferably judge whether or not the apparatus ID of the transmission apparatus 10 which terminates the bypass transmission line 30 or 31 are included in the APS information.

Then, the transmission apparatus 10#6 changes the transmission route in accordance with the operation example illustrated in FIG. 8. Specifically, on the transmission apparatus 10#6, it is judged that the self-transmission-apparatus 10#6 has detected the fault (the step S301 in FIG. 8: Yes), it is judged that the priority of the detected fault is higher (the step S302 in FIG. 8: Yes), it is judged that the self-transmission-apparatus 10#6 terminates the bypass transmission line 31 (the step S303 in FIG. 8: Yes), it is judged that the detected fault is the fault on the bypass transmission line 31 (the step S304 in FIG. 8: Yes), and it is judged that the number of the transmission apparatuses 10 which exist on the east side of the ring transmission line 20 connecting the two transmission apparatuses 10#4 and 10#6 which terminate the bypass transmission line 31 is not same as the number of the transmission apparatuses 10 which exist on the west side of the ring transmission line 20 connecting the two transmission apparatuses 10#4 and 10#6 which terminate the bypass transmission line 31 (the step S305: No). Therefore, as illustrated in FIG. 17, the transmission apparatus 10#6 connects the work line on the bypass side to the protection line 22 of the ring transmission line 20 on the west side, which has the less number of the transmission apparatuses 10 which exist on the ring transmission line 20 connecting the two transmission apparatuses 10#4 and 10#6 which terminate the transmission line 31.

On the other hand, on the transmission apparatus 10#4 located on the opposite side of the bypass transmission line 31, it is judged that the self-transmission-apparatus 10#4 has not detected the fault (the step S301 in FIG. 8: No), it is judged that the priority of the received APS information is higher (the step S308 in FIG. 8: Yes), it is judged that the apparatus ID of the transmission apparatus 10#4 is included in the APS information (the step S309 in FIG. 8: Yes), it is judged that the apparatus IDs of the transmission apparatuses 10#4 and 10#6 which terminate the bypass transmission line 31 are included in the APS information (the step S310 in FIG. 8: Yes), and it is judged that the number of the transmission apparatuses 10 which exist on the east side of the ring transmission line 20 connecting the two transmission apparatuses 10#4 and 10#6 which terminate the bypass transmission line 31 is not same as the number of the transmission apparatuses 10 which exist on the west side of the ring transmission line 20 connecting the two transmission apparatuses 10#4 and 10#6 which terminate the bypass transmission line 31 (the step S305 in FIG. 8: No). Therefore, as illustrated in FIG. 17, the transmission apparatus 10#4 connects the work line on the bypass side to the protection line 22 of the ring transmission line 20 on the east side, which has the less number of the transmission apparatuses 10 which exist on the ring transmission line 20 connecting the two transmission apparatuses 10#4 and 10#6 which terminate the transmission line 31.

On the other hand, on the transmission apparatuses 10#1 to 10#3, 10#5, 10#7 and 10#8 which do not terminate the bypass transmission line 31, it is judged that the self-transmission-apparatus 10#1 to 10#3, 10#5, 10#7 or 10#8 has not detect the fault (the step S301 in FIG. 8: No), it is judged that the priority of the received APS information is higher (the step S308 in FIG. 8: Yes), and it is judged that the apparatus ID of the transmission apparatus 10#1 to 10#3, 10#5, 10#7 or 10#8 is not included in the APS information (the step S309 in FIG. 8: No). Therefore, as illustrated in FIG. 17, each of the transmission apparatuses 10#1 to 10#3, 10#5, 10#7 and 10#8 through-connects the protection line 22 of the ring transmission line 20 on the east side with the protection line 22 of the ring transmission line 20 on the west side.

By this, as illustrated in FIG. 17, the transmission route via the bypass transmission line 31 between the transmission apparatus 10#4 and the transmission apparatus 10#6 is rescued by using the protection line 22 of the ring transmission line 20. On the other hand, the transmission route via the bypass transmission line 30 between the transmission apparatus 10#2 and the transmission apparatus 10#7, which has been rescued by using the protection line 22 of the ring transmission line 20 so far, is no longer rescued.

As explained above, according to the transmission system 1 in the embodiment, for example, when the fault occurs on the bypass transmission line 30 or in similar cases, the signal to be transmitted via the bypass transmission line 30 is transmitted via the protection line 22 of the ring transmission line 20. In other words, in order to rescue the transmission route via the bypass transmission line 30, the ring transmission line 20 can be used. Thus, even if the protection line of the bypass transmission line 30 is not laid separately, it is possible to ensure high reliability of the signal to be transmitted via the bypass transmission line 30. Therefore, the reliability of the transmission system 1 can be preferably ensured without causing an increase in cost due to the separate laying of the protection line of the bypass transmission line 30.

Moreover, the transmission apparatus 10 (particularly, the transmission apparatus 10 which does not the detect the fault) can preferably judge whether or not there is the change request for the transmission route including the bypass transmission line 30, with reference to the topology bypass information (refer to the step S310 in FIG. 8, or the like). Therefore, the transmission apparatus 10 can properly determine whether to perform the change in the transmission route including the ring transmission line 20 (namely, the change in the same manner as the BLSR) or to perform the change in the transmission route including the bypass transmission line 30 (namely, the change in a different manner from the BLSR).

More specifically, the transmission apparatus 10 can preferably judge whether or not there is the change request for the transmission route including the bypass transmission line 30, on the basis of whether the apparatus ID included in the bypass portion of the topology bypass information matches the apparatus ID included in the APS information (refer to the step S310 in FIG. 8, or the like). Therefore, the transmission apparatus 10 can determine whether to perform the change in the transmission route including the ring transmission line 20 (namely, the change in the same manner as the BLSR) or to perform the change in the transmission route including the bypass transmission line 30 (namely, the change in a different manner from the BLSR), properly and relatively easily.

Moreover, as the topology bypass information, it is possible to use information in which the bypass portion is newly added to topology information (or topology portion) used in the existing BLSR or the like. Therefore, the transmission apparatus can receive the aforementioned various effects without significantly changing the framework of the information to be used.

Moreover, the transmission apparatus 10 can connect the bypass transmission line 30 to the protection line 22 of the ring transmission line 20, when the self-transmission-apparatus 10 terminates the bypass transmission line 30. Therefore, the transmission route via the bypass transmission line 30 can be preferably rescued by using the ring transmission line 20.

Moreover, when connecting the bypass transmission line 30 to the protection line 22 of the ring transmission line 20, the transmission apparatus 10 can connect the bypass transmission line 30 to the protection line 22 on the side having the less number of the transmission apparatuses 10 located on the ring transmission line 20. Therefore, it is possible to efficiently transmit a signal after the change in the transmission route.

Moreover, the transmission apparatus 10 can properly change the transmission route on the basis of the apparatus ID when the number of the transmission apparatuses 10 located on the east side of the ring transmission line 20 is same as the number of the transmission apparatuses 10 located on the west side of the ring transmission line 20. Therefore, it is possible to eliminate the occurrence of an error at the time of change in the transmission route. Incidentally, the judgment based on the apparatus ID is merely one example, and other criteria (e.g. some type of prioritizing, negotiation or relation among the transmission apparatuses 10, and the like) may be used to determine which side of the protection line 22 of the ring transmission line 20 is used to connect the bypass transmission line 30.

With regard to the embodiment explained above, the following additional statements are further disclosed.

(Additional Statement 1)

A transmission apparatus located on a communication transmission line including a loop-shaped ring transmission line and a bypass transmission line for bypassing predetermined two points on the ring transmission line,

the transmission apparatus includes:

a judging unit which judges whether or not there is a change request for a transmission route of a signal which is to be transmitted via the bypass transmission line; and

a changing unit which changes the transmission route of the signal on the communication transmission line such that the signal which is to be transmitted via the bypass transmission line is transmitted via at least one portion of the ring transmission line, when it is judged that there is the change request.

(Additional Statement 2)

The transmission apparatus according to the additional statement 1, further including an obtaining unit which obtains apparatus information, the apparatus information indicating a transmission apparatus which terminates the bypass transmission line,

the judging unit judging whether or not there is the change request for the transmission route of the signal which is to be transmitted via the bypass transmission line on the basis of the apparatus information.

(Additional Statement 3)

The transmission apparatus according to the additional statement 2, wherein

the apparatus information includes bypass information indicating identification information of the transmission apparatus which terminates the bypass transmission line.

(Additional Statement 4)

The transmission apparatus according to the additional statement 2, wherein

the apparatus information includes:

(i) topology information in which identification information of the transmission apparatuses located on the ring transmission line are arranged in order, starting from the identification information of a self-apparatus; and

(ii) bypass information in which the identification information of the transmission apparatus which terminates the bypass transmission line out of the identification information included in the topology information is associated with the identification information of a transmission apparatus on an opposite side of the bypass transmission line.

(Additional Statement 5)

The transmission apparatus according to the additional statement 3 or 4, wherein

the change request includes the identification information of the transmission apparatus which is a start point for changing the transmission route and the identification information of the transmission apparatus which is an end point for changing the transmission route, and

the judging unit judges that there is the change request for the transmission route of the signal which is to be transmitted via the bypass transmission line, when the identification information included in the change request transmitted from another transmission apparatus matches the identification information included in the bypass information.

(Additional Statement 6)

The transmission apparatus according to any one of the additional statements 1 to 5, wherein the changing unit changes the transmission route so as to connect a work line of the bypass transmission line to a protection line of the ring transmission line, when a self-apparatus is a transmission apparatus which terminates the bypass transmission line.

(Additional Statement 7)

The transmission apparatus according to the additional statement 6, wherein the changing unit changes the transmission route so as to connect the work line of the bypass transmission line to the protection line on a side having the less number of transmission apparatuses which exist between the self-apparatus and a transmission apparatus on an opposite side of the bypass transmission line, out of the protection line on one side of the ring transmission line and the protection line on the other side of the ring transmission line.

(Additional Statement 8)

The transmission apparatus according to the additional statement 6, wherein the changing unit changes the transmission route so as to connect the work line of the bypass transmission line to at least one of the protection line on one side of the ring transmission line and the protection line on the other side of the ring transmission line, selected in accordance with a predetermined criterion which is common to both the self-apparatus and the transmission apparatus on the opposite side of the bypass transmission line, when the self-apparatus is the transmission apparatus which terminates the bypass transmission line.

(Additional Statement 9)

The transmission apparatus according to the additional statement 6, wherein the changing unit changes the transmission route so as to connect the work line of the bypass transmission line to at least one of the protection line on one side of the ring transmission line and the protection line on the other side of the ring transmission line, selected in accordance with a predetermined criterion which is common to both the self-apparatus and the transmission apparatus on the opposite side of the bypass transmission line, when the self-apparatus is the transmission apparatus which terminates the bypass transmission line and when the numbers of transmission apparatuses which exist between the self-apparatus and the transmission apparatus on an opposite side of the bypass transmission line are the same between one side and the other side.

(Additional Statement 10)

The transmission apparatus according to the additional statement 8 or 9, wherein the changing unit (i) changes the transmission route so as to connect the work line of the bypass transmission line to the protection line on the one side of the ring transmission line, when the predetermined criterion is satisfied between identification information of the self-apparatus and identification information of the transmission apparatus on the opposite side of the bypass transmission line and (ii) changes the transmission route so as to connect the work line of the bypass transmission line to the protection line on the other side of the ring transmission line, when the predetermined criterion is not satisfied between the identification information of the self-apparatus and the identification information of the transmission apparatus on the opposite side of the bypass transmission line.

(Additional Statement 11)

The transmission apparatus according to any one of the additional statements 1 to 10, wherein

the change request includes identification information of the transmission apparatuses which is a start point for changing the transmission route and identification information of the transmission apparatuses which is an end point for changing the transmission route, and

when the change request does not include identification information of a self-apparatus, the changing unit changes the transmission route so as to through-connect a protection line on one side of the ring transmission line and a protection line on the other side of the ring transmission line.

(Additional Statement 12)

A method of changing a transmission route in a transmission apparatus located on a communication transmission line including a loop-shaped ring transmission line and a bypass transmission line for bypassing predetermined two points on the ring transmission line,

the method including:

judging whether or not there is a change request for the transmission route of the signal which is to be transmitted via the bypass transmission line; and

changing the transmission route of the signal on the communication transmission line such that the signal which is to be transmitted via the bypass transmission line is transmitted via at least one portion of the ring transmission line, when it is judged that there is the change request.

(Additional Statement 13)

A transmission system comprising:

a loop-shaped ring transmission line;

a plurality of transmission apparatuses located on the ring transmission line; and

a bypass transmission line for bypassing two transmission apparatuses located at predetermined two points on the ring transmission line,

at least one of the plurality transmission apparatuses including:

a judging unit which judges whether or not there is a change request for the transmission route of the signal which is to be transmitted via the bypass transmission line; and

a changing unit which changes the transmission route of the signal on the communication transmission line such that the signal which is to be transmitted via the bypass transmission line is transmitted via at least one portion of the ring transmission line, when it is judged that there is the change request.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus located on a communication transmission line including a loop-shaped ring transmission line and a bypass transmission line for bypassing predetermined two points on the ring transmission line,
the transmission apparatus comprising:
a judging unit which judges whether or not there is a change request for a transmission route of a signal which is to be transmitted via the bypass transmission line; and
a changing unit which changes the transmission route of the signal on the communication transmission line such that the signal which is to be transmitted via the bypass transmission line is transmitted via at least one portion of the ring transmission line, when it is judged that there is the change request.

2. The transmission apparatus according to claim 1, further comprising an obtaining unit which obtains apparatus information, the apparatus information indicating a transmission apparatus which terminates the bypass transmission line,
the judging unit judging whether or not there is the change request for the transmission route of the signal which is to be transmitted via the bypass transmission line on the basis of the apparatus information.

3. The transmission apparatus according to claim 2, wherein
the apparatus information includes:
(i) topology information in which identification information of the transmission apparatuses located on the ring transmission line are arranged in order, starting from the identification information of a self-apparatus, and
(ii) bypass information in which the identification information of the transmission apparatus which terminates the bypass transmission line out of the identification information included in the topology information is associated with the identification information about a transmission apparatus on an opposite side of the bypass transmission line.

4. The transmission apparatus according to claim 3, wherein
the change request includes the identification information of the transmission apparatus which is a start point for changing the transmission route and the identification information of the transmission apparatus which is an end point for changing the transmission route, and
the judging unit judges that there is the change request for the transmission route of the signal which is to be transmitted via the bypass transmission line, when the identification information included in the change request transmitted from another transmission apparatus matches the identification information included in the bypass information.

5. The transmission apparatus according to claim 1, wherein the changing unit changes the transmission route so as to connect a work line of the bypass transmission line to a protection line of the ring transmission line, when a self-apparatus is a transmission apparatus which terminates the bypass transmission line.

6. The transmission apparatus according to claim 5, wherein the changing unit changes the transmission route so as to connect the work line of the bypass transmission line to the protection line on a side having the less number of transmission apparatuses which exist between the self-apparatus and a transmission apparatus on an opposite side of the bypass transmission line, out of the protection line on one side of the ring transmission line and the protection line on the other side of the ring transmission line.

7. The transmission apparatus according to claim 5, wherein the changing unit changes the transmission route so as to connect the work line of the bypass transmission line to at least one of the protection line on one side of the ring transmission line and the protection line on the other side of the ring transmission line, selected in accordance with a predetermined criterion which is common to both the self-apparatus and the transmission apparatus on the opposite side of the bypass transmission line, when the self-apparatus is the transmission apparatus which terminates the bypass transmission line.

8. A method of changing a transmission route in a transmission apparatus located on a communication transmission line including a loop-shaped ring transmission line and a bypass transmission line for bypassing predetermined two points on the ring transmission line,
the method comprising:
judging whether or not there is a change request for the transmission route of the signal which is to be transmitted via the bypass transmission line; and
changing the transmission route of the signal on the communication transmission line such that the signal which is to be transmitted via the bypass transmission line is transmitted via at least one portion of the ring transmission line, when it is judged that there is the change request.
